(19) United States
(12) Patent Application Publication
(10) Pub. No.: US 2014/0211670 A1
(43) Pub. Date: Jul. 31, 2014

(54) Wireless Network Synchronization

(71) Applicant: Broadcom Corporation, Irvine, CA (US)

(72) Inventors: Sam P. Alex, Sunnyvale, CA (US); Amin Mobasher, Sunnyvale, CA (US); Louay Jalloul, San Jose, CA (US)

(21) Appl. No.: 14/148,582

(22) Filed: Jan. 6, 2014

Related U.S. Application Data
(60) Provisional application No. 61/757,655, filed on Jan. 28, 2013.

(51) Int. Cl. H04W 56/00; H04L 5/14

(52) U.S. Cl. CPC H04W 56/00; H04L 5/14
USPC 370/280

(57) ABSTRACT

Provided are various implementations of a wireless network synchronization solution. In one implementation, such a solution includes a mobile communication device including a receiver for use with the wireless network. The receiver is configured to receive a downlink communication from the wireless network, to detect a primary synchronization signal (PSS) at a PSS subframe symbol of the downlink communication, and to detect a secondary synchronization signal (SSS) at an SSS subframe symbol of the downlink communication. The receiver is further configured to identify the downlink communication as being duplexed using one of a first duplexing mode and a second duplexing mode when the PSS subframe symbol follows the SSS subframe symbol, and to identify the downlink communication as being duplexed using the other of the first duplexing mode and the second duplexing mode when the PSS subframe symbol precedes the SSS subframe symbol.

### RELATED APPLICATION(S)

This application is based on and claims priority from U.S. Provisional Patent Application Ser. No. 61/757,655, filed Jan. 28, 2013, which is hereby incorporated by reference in its entirety.

### BACKGROUND

As mobile communication devices, such as tablet computers and smartphones, become more powerful and versatile, they are increasingly used by consumers to access rich, bandwidth intensive media content, such as video content, over wireless networks. In order to meet the requirements of this ever increasing and ever more demanding media consumption while concurrently satisfying established consumer expectations with respect to service quality, more efficient and robust wireless communication solutions are being explored.

One approach to improving wireless network performance includes providing increased wireless cell coverage and enhancing coordination between wireless cell types. For example the use of more small cells and reductions in the reference signaling required of those small cells can reduce latency and increase efficiency. At the physical layer, such improvements may be enabled by introduction of a Long Term Evolution (LTE) New Carrier Type (NCT). However, an NCT optimized for state-of-the-art wireless network performance may not be backward compatible with legacy user equipment that may remain in use for a significant period of time. As a result, it is desirable that such an NCT be structured so as to be substantially transparent to existing legacy user equipment.

### SUMMARY

The present disclosure is directed to wireless network synchronization, as shown in and/or described in connection with at least one of the figures, and as set forth more completely in the claims.

### BRIEF DESCRIPTION OF THE DRAWINGS

FIG. 1A shows a communication environment including mobile communication devices receiving downlink communications from a wireless network, according to one implementation;

FIG. 1B shows a more detailed representation of an exemplary mobile communication device suitable for use in the communication environment of FIG. 1A;

FIG. 1C shows a more detailed representation of an exemplary base station suitable for use in the communication environment of FIG. 1A;

FIG. 2 shows an exemplary radio frame from the downlink communications shown in FIG. 1A;

FIG. 3 shows two exemplary physical resource blocks (PRBs) corresponding to selected subframes of the radio frame of FIG. 2, according to one implementation;

FIG. 4 shows two exemplary PRBs corresponding to selected subframes of the radio frame of FIG. 2, according to another implementation; and

FIG. 5 is a flowchart presenting an exemplary method for identifying a downlink communication from a wireless network.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

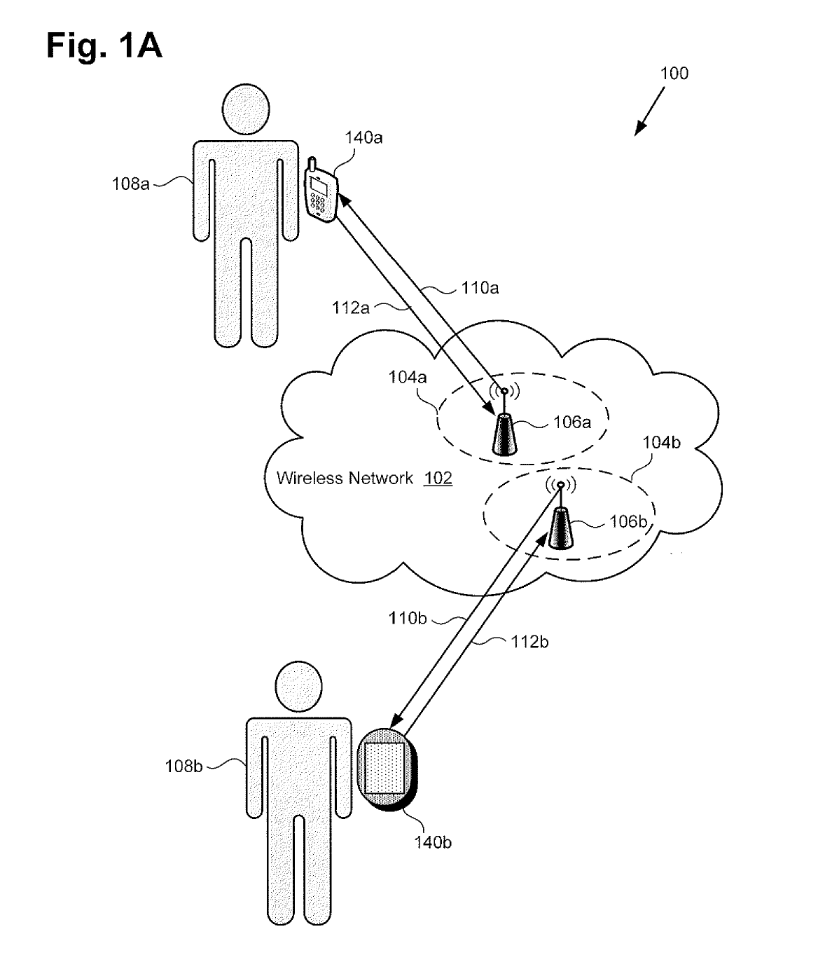

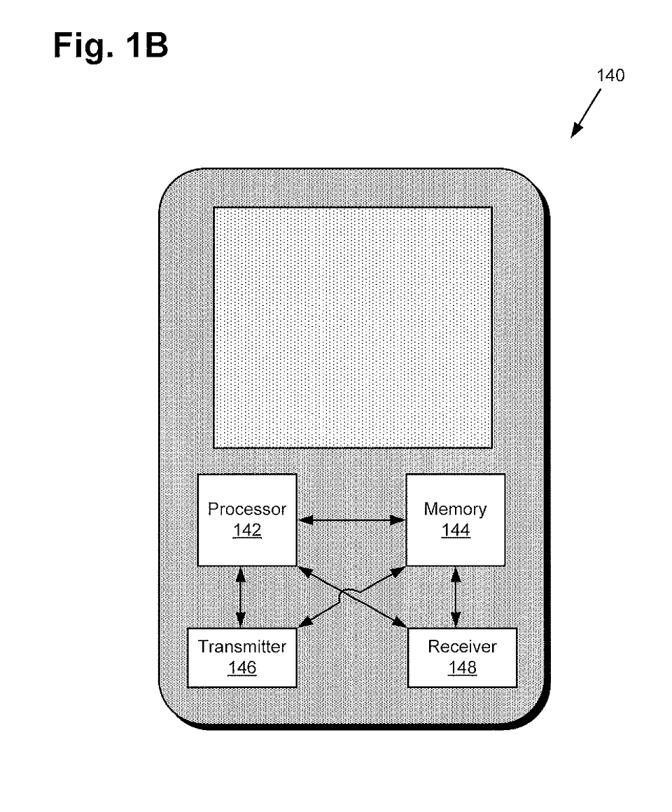

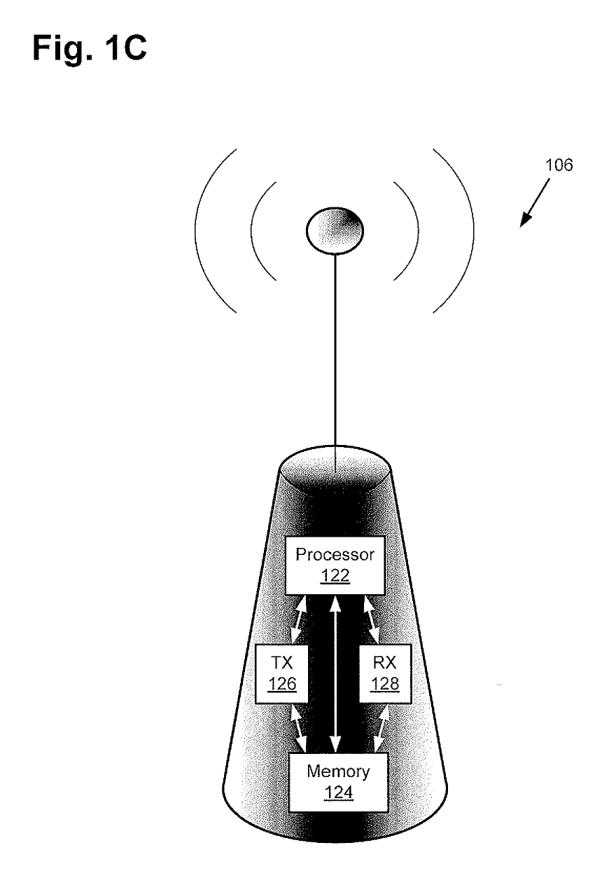

FIG. 1A shows exemplary communication environment 100 including user equipment in the form of mobile communication devices 140a and 140b receiving respective downlink communications 110a and 110b from wireless network 102. Exemplary wireless network 102 may be a 3^{rd} Generation Partnership Project (3GPP) Long Term Evolution (LTE) network configured to utilize a New Carrier Type developed for the 3GPP Radio Layer 1 (RAN1), for example. As shown in FIG. 1A, wireless network 102 includes cells 104a and 104b having respective base stations 106a and 106b.

One or both of cells 104a and 104b may be a macro cell covering a relatively large geographical area, or a small cell, such as a pico cell or femto cell, as known in the art. Base stations 106a and 106b may correspond respectively to the type of cell (i.e., cells 104a and 104b) they occupy. In other words, if cell 104a is a macro cell while cell 104b is a pico cell, base station 106a may be configured as a macro cell base station while base station 106b may be configured as a pico cell base station, and so forth. As a result, wireless network 102 may be a heterogeneous network including different types of base stations supporting different types of cells. Moreover, wireless network 102 may be configured to support synchronous or asynchronous operation.

As shown in FIG. 1A, user 108a utilizes mobile communication device 140a to communicate with wireless network 102. Similarly, user 108b utilizes mobile communication device 140b to communicate with wireless network 102. Mobile communication devices 140a and 140b receive respective downlink communications 110a and 110b from wireless network 102, and transmit respective uplink communications 112a and 112b to wireless network 102. As depicted in FIG. 1A, mobile communication device 140a may be a mobile telephone, while mobile communication device 140b may be a touch screen device such as a smartphone or tablet computer. Other examples of user equipment corresponding to one or both of mobile communication devices 140a and 140b include a laptop computer, netbook, gaming console, or any other kind of mobile device or system utilized as a transceiver in modern electronics applications.

Moving to FIG. 1B, FIG. 1B shows a more detailed representation of exemplary mobile communication device 140 suitable for use in communication environment 100, in FIG. 1A. Mobile communication device 140, in FIG. 1B, includes processor 142, memory 144, transmitter 146, and receiver 148. It is noted that processor 142 is a hardware processor, while memory 144 is a non-transitory memory. It is further noted that transmitter 146 and receiver 148 are coupled to processor 142 and memory 144 so as to be controlled by processor 142 and so as to be able to write/read data to/from memory 144. Mobile communication device 140 is exemplary of any user equipment suitable for use with wireless network 102, in FIG. 1A. For example, mobile communication device 140 can correspond to either or both of mobile communication devices 140a and 140b, in FIG. 1A.

Referring to FIG. 1C, FIG. 1C shows a more detailed representation of exemplary base station 106 suitable for use in communication environment 100, in FIG. 1A. Base station 106, in FIG. 1C, includes processor 122, such as a hardware processor, and memory 124, which may be non-transitory memory. Base station also includes transmitter 126 and receiver 128 coupled to processor 122 and memory 124 so as to be controlled by processor 122 and so as to be able to write/read data to/from memory 124. Base station 106 is exemplary of any of the various types of base stations utilized to support cells in wireless network 102, in FIG. 1A. For example, base station 106 can correspond to either or both of base stations 106a and 106b of respective cells 104a and 104b, in FIG. 1A.

As discussed above, as mobile communication devices, such as mobile communication device 140 in FIG. 1B, become more powerful and versatile, they are increasingly utilized by consumers, such as users 108a and 108b in FIG. 1A, to access rich, bandwidth intensive media content. In order to meet the requirements of this ever increasing and ever more demanding media consumption while concurrently satisfying the expectations of users 108a and 108b with respect to service quality, wireless network 102 should be both energy-efficient and robust.

At the physical layer, the desired network capability may be enabled by introduction of a higher performance NCT. However, an NCT optimized for state-of-the-art wireless network technology may not be backward compatible for legacy user equipment that may remain in use for a significant period of time. The present application discloses a solution enabling an NCT network to coexist with legacy user equipment with which the NCT may not be backward compatible. In one implementation, the NCT is configured to map a primary synchronization signal (PSS) and a secondary synchronization signal (SSS) utilized in LTE downlink communications for cell detection and cell acquisition, away from their positions in legacy frameworks. Moreover, in some implementations, the duplexing mode used to provide the downlink communication may be distinguished based on the relative locations of the PSS and SSS within a physical resource block (PRB) of the downlink communication. For example, in one implementation, the duplexing mode may be identified as Time-Division Duplexing (TDD) when the PSS precedes the SSS, and as Frequency-Division Duplexing (FDD) when the SSS precedes the PSS.

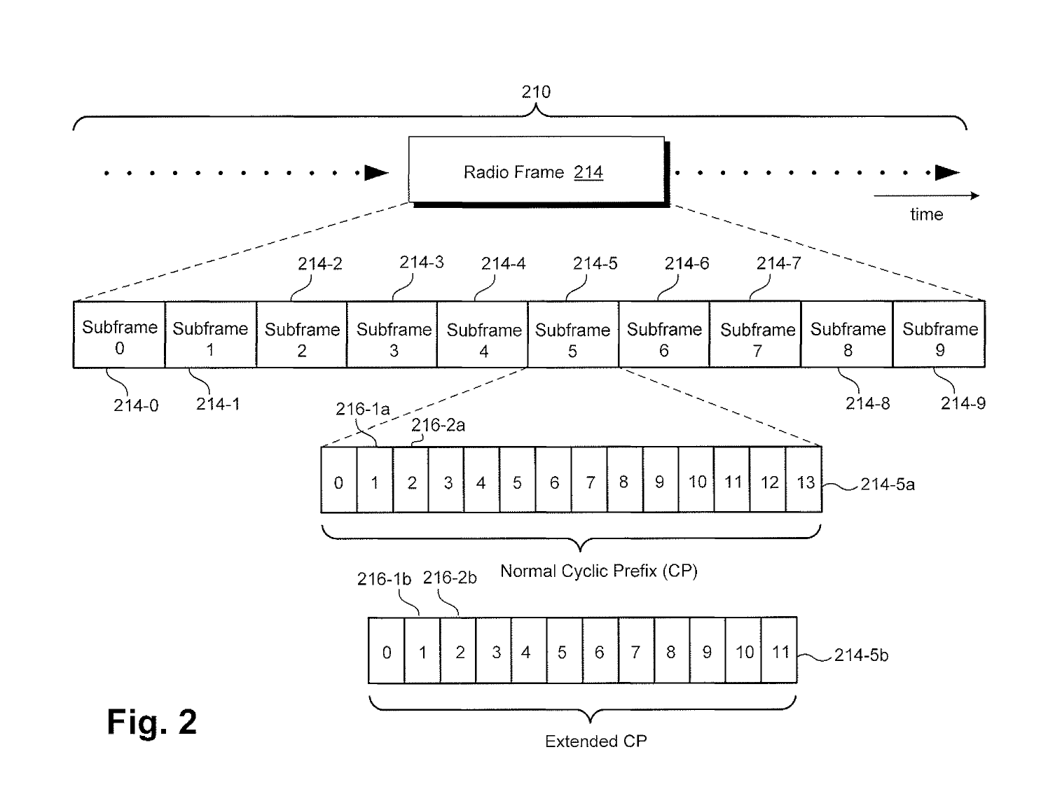

Referring to FIG. 2, FIG. 2 shows exemplary radio frame 214 from downlink communication 210. It is noted that downlink communication 210 corresponds in general to downlink communications 110a and 110b, in FIG. 1A. In LTE, downlink communication 210 including radio frame 214 is typically sent from base station 106, in FIG. 1B, using Orthogonal Frequency-Division Multiplexing (OFDM). Radio frame 214 may have a duration of ten milliseconds (10 ms) and may be partitioned into ten subframes, for example. The ten subframes of radio frame 214 may be labeled subframes 0, 1, 2, 3, 4, 5, 6, 7, 8, and 9, and are respectively identified by reference numbers 214-0, 214-1, 214-2, 214-3, 214-4, 214-5, 214-6, 214-7, 214-8, and 214-9.

As shown in FIG. 2, each subframe of radio frame 214 may be further partitioned into multiple OFDM symbol periods, with the specific number of symbol periods depending on whether the subframes utilize a normal cyclic prefix (CP) or an extended CP format. As specific examples, FIG. 2 shows subframe 5 (214-5) in detail as normal CP subframe 214-5a having fourteen symbol periods and as extended CP subframe 214-5b having twelve symbol periods. Normal CP subframe 214-5a includes symbol periods 0, 1, 2, 3, 4, 5, 6, 7, 8, 9, 10, 11, 12, and 13, while extended CP subframe 214-b includes symbol periods 0, 1, 2, 3, 4, 5, 6, 7, 8, 9, 10, and 11. Exemplary symbol periods 1 and 2 are identified by respective reference numbers 216-1a and 216-2a in normal CP subframe 214-5a, and by respective reference numbers 216-1b and 216-2b in extended CP subframe 214-5b.

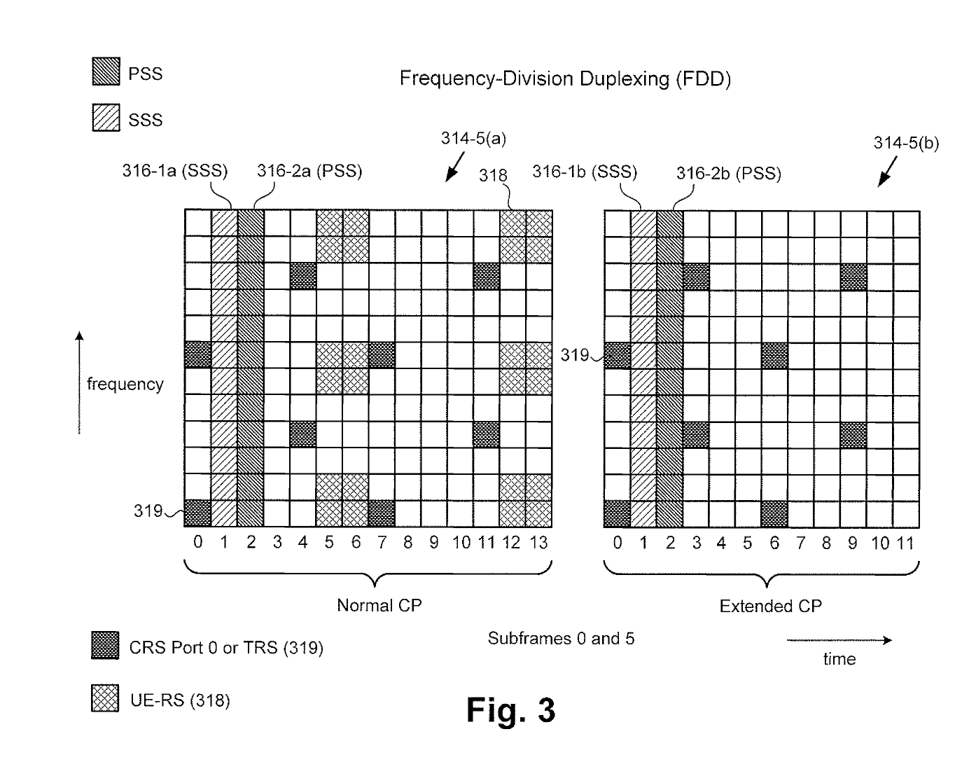

Continuing to FIG. 3, FIG. 3 shows two exemplary PRBs corresponding in general to subframe 214-5 (subframe 5) of radio frame 214, in FIG. 2, when FDD mode is used to provide downlink signal 210. It is noted that although PRBs from subframe 214-5 are represented in FIG. 3 for exemplary purposes, the PSS and SSS mapping shown in FIG. 3 is equally applicable to subframe 214-0 (subframe 0) of radio frame 214. PRB 314-5a, in FIG. 3, corresponds in general to normal CP subframe 214-5a, in FIG. 2, while PRB 314-5b corresponds in general to extended CP subframe 214-5b.

PRB 314-5a has cell specific reference signals (CRSS) or tracking reference signal (TRSs) at symbol periods 0, 4, 7, and 11, of which exemplary CRS/TRS 319 is identified as such in FIG. 3. In addition, PRB 314-5a has user equipment-specific reference signals for demodulation (UE-RSs) at symbol periods 5, 6, 12, and 13, of which exemplary UE-RS 318 is identified as such. Like PRB 314-5a, PRB 314-5b includes CRSs/TRSs, of which exemplary CRS/TRS 319 is identified as such. However, unlike PRB 314-5a, the CRSs/TRSs of PRB 314-5b are at symbol periods 0, 3, 6, and 9.

As shown in FIG. 3, both PRB 314-5a and PRB 314-5b have respective PSS subframe symbols 316-2a and 316-2b occupied by the PSS, and respective SSS subframe symbols 316-1a and 316-1b occupied by the SSS. According to the exemplary implementation shown in FIG. 3, PSS subframe symbols 316-2a and 316-2b of respective PRBs 314-5a and 314-5b substantially coincide with symbol period 2.

It is noted that the initial subframe symbol period of each radio subframe, such as symbol period 0 of subframes 214-5a and 214-5b in FIG. 2, is identified using the index zero (0), i.e., the initial symbol period is the “zeroth” symbol period. As a result, PSS subframe symbol 316-2a/316-2b corresponds to the second OFDM symbol period of subframe 214-5a/214-5b, i.e., OFDM symbol period 216-2a/216-2b. Moreover, SSS subframe symbol 316-1a/316-1b, in FIG. 3, corresponds to the first OFDM symbol period of subframe 214-5a/214-5b, i.e., OFDM symbol period 216-1a/216-1b. Thus, in one implementation, PSS subframe symbol 316-2a/316-2b and SSS subframe symbol 316-1a/316-1b are at adjoining symbol periods, with PSS subframe symbol 316-2a/316-2b) following SSS subframe symbol 316-1a/316-1b.

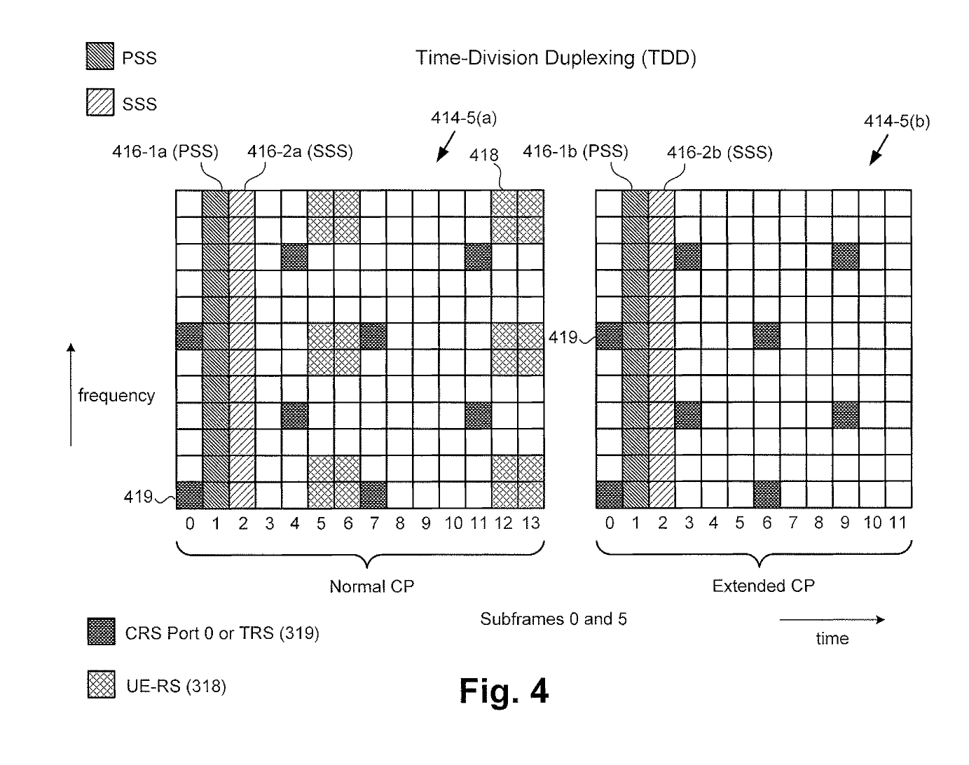

Moving to FIG. 4, FIG. 4 shows two exemplary PRBs corresponding in general to subframe 214-5 (subframe 5) of radio frame 214, in FIG. 2, when TDD mode is used to provide downlink signal 210. As noted above by reference to FIG. 3, although PRBs from subframe 214-5 are represented for exemplary purposes, the PSS and SSS mapping shown in FIG. 4 is equally applicable to subframe 214-0 (subframe 0) of radio frame 214. PRB 414-5a, in FIG. 4, corresponds in general to normal CP subframe 214-5a, in FIG. 2, while PRB 414-5b corresponds in general to extended CP subframe 214-5b.

Like PRB 314-5a, in FIG. 3, PRB 414-5a, in FIG. 4 has CRSs/TRSs at symbol periods 0, 4, 7, and 11, of which exemplary CRS/TRS 419 is identified as such. In addition, PRB 414-5a also has UE-RSs at symbol periods 5, 6, 12, and 13, of which exemplary UE-RS 318 is identified as such. Like PRB 414-5a, PRB 414-5b includes CRSs/TRSs, of which exemplary CRS/TRS 419 is identified as such. However, like PRB 314-5b, the CRSs/TRSs of PRB 414-5b are at symbol periods 0, 3, 6, and 9.

Both PRB 414-5a and PRB 414-5b have respective PSS subframe symbols 416-1a and 416-1b occupied by the PSS, and respective SSS subframe symbols 416-2a and 416-2b occupied by the SSS. According to the exemplary implementation shown in FIG. 4, PSS subframe symbols 416-1a and 416-1b of respective PRBs 414-5a and 414-5b substantially coincide with symbol period 1. That is to say, PSS subframe symbol 416-1a/416-1b corresponds to OFDM symbol period 216-1a/216-1b, in FIG. 2, i.e., the first OFDM symbol period of subframe 214-5a/214-5b. Furthermore, SSS subframe symbol 416-2a/416-2b, in FIG. 4, corresponds to OFDM symbol period 216-2a/216-2b, in FIG. 2, i.e., the second OFDM symbol period of subframe 214-5a/214-5b. Thus, in one implementation, PSS subframe symbol 416-1a/416-1b and SSS subframe symbol 416-2a/416-2b are at adjoining symbol periods, with PSS subframe symbol 416-1a/416-1b preceding SSS subframe symbol 416-2a/416-2b.

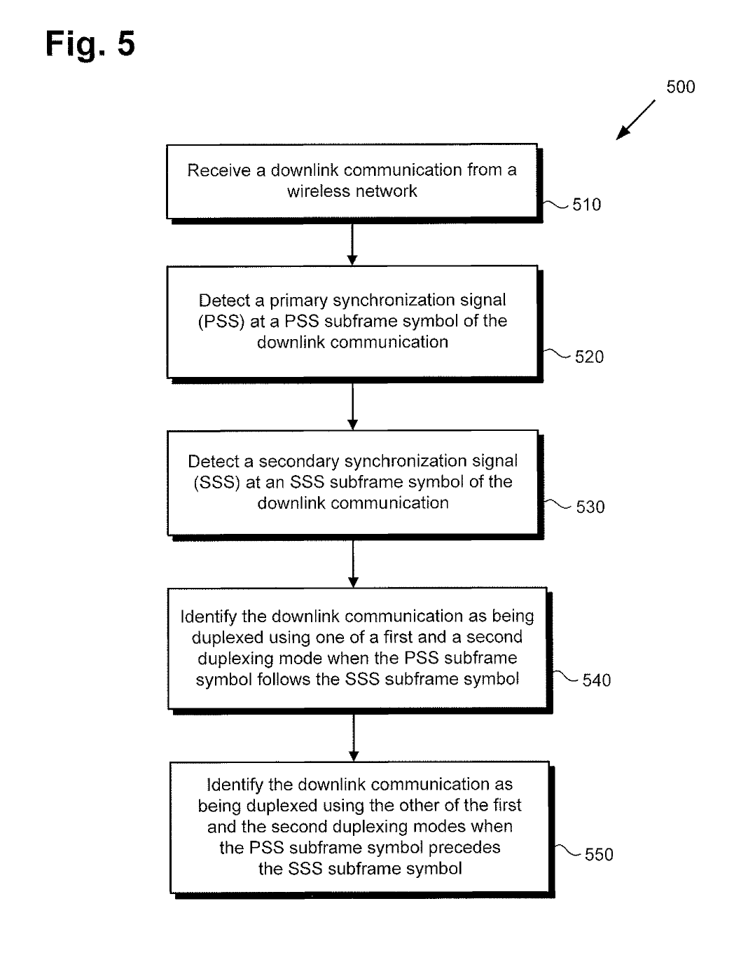

FIGS. 1A, 1B, 1C, 2, 3, and 4 will now be further described by reference to FIG. 5, which presents flowchart 500 describing an exemplary method for identifying a downlink communication from a wireless network. With respect to the method outlined in FIG. 5, it is noted that certain details and features have been left out of flowchart 500 in order not to obscure the discussion of the inventive features in the present application.

Referring to FIGS. 1A, 1B, IC, and 2 in combination with FIG. 5, flowchart 500 begins with receiving downlink communication 110a/110b/210 from wireless network 102 (510). As shown in FIGS. 1A and 1B, downlink communications 110a and 110b can be received by user equipment depicted as mobile communication device 140, using receiver 148 in combination with processor 142 and memory 144. Moreover, downlink communications 110a and 110b may be provided (i.e., transmitted) by base station 106, using processor 122 and memory 124. As noted above, wireless network 102 may be an LTE network employing an NCT, for example LTE release 12, and downlink communication 110a/110b/210 may be an OFDM downlink communication. Referring, in addition, to FIGS. 3 and 4 in combination with FIGS. 1A, 1B, 1C, 2, and 5, flowchart 500 continues with detecting a PSS at PSS subframe symbol 316-2a/316-2b/416-1a/416-1b of downlink communication 210 (520). The PSS may be included at PSS subframe symbol 316-2a/316-2b/416-1a/416-1b by base station 106, using processor 122 and memory 124, and may be detected by receiver 148 of mobile communication device 140, under the control of processor 142 and in conjunction with use of memory 144. According to the implementations shown in FIGS. 2, 3, and 4, the PSS may be detected at either the first or the second OFDM symbol period in multiple subframes, such as subframe 214-0 (subframe 0) and subframe 214-5 (subframe 5) of radio frame 214.

Continuing to refer to FIGS. 1A, 1B, 1C, 2, 3, and 4 in combination with FIG. 5, flowchart 500 proceeds with detecting an SSS at SSS subframe symbol 316-1a/316-1b/416-2a/416-2b of downlink communication 210 (530). The SSS may be included at SSS subframe symbol 316-1a/316-1b/416-2a/416-2b by base station 106, using processor 122 and memory 124, and may be detected by receiver 148 of mobile communication device 140, under the control of processor 142 and in conjunction with use of memory 144. Moreover, according to the implementations shown in FIGS. 2, 3, and 4, the SSS, like the PSS, may be detected at either the first or the second OFDM symbol period in multiple subframes, i.e., subframe 214-0 (subframe 0) and subframe 214-5 (subframe 5) of radio frame 214.

It is reiterated that the initial subframe symbol period, such as symbol period 0 of subframes 214-5a and 214-5b in FIG. 2, is identified as the zeroth symbol period. With respect to the first and second symbol periods, i.e., symbol periods 216-1a/216-1b and 216-2a/216-2b, it is contemplated that those symbol periods will remain substantially free of reference and control signals in the NCT. Consequently, mapping of the PSS and the SSS exclusively to the first and second symbol periods can advantageously avoid collisions of the PSS and SSS with NCT control and/or reference signals.

Referring to FIGS. 1A, 1B, 2, and 3 in combination with FIG. 5, flowchart 500 continues with identifying downlink communication 110a/110b/210 as being duplexed using one of a first and a second duplexing mode when PSS subframe symbol 316-2a/316-2b follows SSS subframe 316-1a/316-1b (540). Identification of the duplexing mode used to provide downlink communication 110a/110b may be performed by receiver 148 of mobile communication device 140, under the control of processor 142 and in conjunction with use of memory 144. As shown in FIG. 3, in one implementation, the duplexing mode may be identified as FDD when PSS subframe symbol 316-2a/316-2b follows SSS subframe symbol 316-1a/316-1b.

Referring to FIGS. 1A, 1B, 2, and 4 in combination with FIG. 5, flowchart 500 may conclude with identifying downlink communication 110a/110b/210 as being duplexed using the other of the first and the second duplexing mode when PSS subframe symbol 416-1a/416-1b precedes SSS subframe symbol 416-2a/416-2b (550). As noted above, identification of the duplexing mode used to provide downlink communication 110a/110b may be performed by mobile communication device 140, under the control of processor 142 and in conjunction with use of memory 144. Furthermore, as shown in FIG. 4, in one implementation, the duplexing mode may be identified as TDD when PSS subframe symbol 416-1a/416-1b precedes SSS subframe symbol 416-2a/416-2b.

It is noted that although FIGS. 3 and 4 show PSS subframe symbol 316-2a/316-2b following SSS subframe symbol 316-1a/316-1b for FDD, and PSS subframe symbol 416-la/416-1b preceding SSS subframe symbol 416-2a/416-2b for TDD, that representation is merely exemplary. In other implementations, the opposite mapping sequence may be used for identification of the duplexing mode, i.e., PSS following SSS for TDD, and PSS preceding SSS for FDD. Moreover, in other implementations, one or more other duplexing modes may be utilized in place of one or both of the FDD and TDD modes shown in respective FIGS. 3 and 4.

Thus, the present application discloses a wireless network synchronization solution enabling an NCT network to coexist with legacy user equipment with which the NCT may not be backward compatible. By mapping the PSSs and SSSs utilized in LTE downlink communications for cell detection and cell acquisition to first and second symbol periods of the downlink communication radio subframes, the NCT communications are rendered substantially transparent to existing legacy user equipment. In addition, by reversing the symbol period ordering of the PSS and SSS subframe symbol mapping based on the duplexing mode used to provide the downlink communication, the present solution enables identification of the downlink communication frame structure.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A mobile communication device comprising:
a receiver configured to:
receive a downlink communication from a wireless network;
detect a primary synchronization signal (PSS) at a PSS subframe symbol of the downlink communication;
detect a secondary synchronization signal (SSS) at an SSS subframe symbol of the downlink communication;
identify the downlink communication as being duplexed using one of a first duplexing mode and a second duplexing mode when the PSS subframe symbol follows the SSS subframe symbol;
identify the downlink communication as being duplexed using the other of the first duplexing mode and the second duplexing mode when the PSS subframe symbol precedes the SSS subframe symbol.

2. The mobile communication device of claim 1, wherein the wireless network comprises a Long Term Evolution (LTE) New Carrier Type (NCT) network.

3. The mobile communication device of claim 1, wherein the first duplexing mode is one of Frequency-Division Duplexing (FDD) and Time-Division Duplexing (TDD).

4. The mobile communication device of claim 1, wherein the PSS subframe symbol and the SSS subframe symbol are detected at adjoining symbol periods of the downlink communication.

5. The mobile communication device of claim 1, wherein the PSS subframe symbol is detected at a second Orthogonal Frequency-Division Multiplexing (OFDM) symbol period in a plurality of subframes of the downlink communication.

6. The mobile communication device of claim 1, wherein the SSS subframe symbol is detected at a second OFDM symbol period in a plurality of subframes of the downlink communication.

7. The mobile communication device of claim 1, wherein the PSS subframe symbol and the SSS subframe symbol are detected at adjoining OFDM symbol periods of a subframe zero (subframe 0) and a subframe five (subframe 5) of a radio frame of the downlink communication.

8. A method for identifying a downlink communication from a wireless network, the method comprising:
receiving the downlink communication from the wireless network;
detecting a primary synchronization signal (PSS) at a PSS subframe symbol of the downlink communication;
detecting a secondary synchronization signal (SSS) at an SSS subframe symbol of the downlink communication;
identifying the downlink communication as being duplexed using one of a first duplexing mode and a second duplexing mode when the PSS subframe symbol follows the SSS subframe symbol;
identifying the downlink communication as being duplexed using the other of the first duplexing mode and the second duplexing mode when the PSS subframe symbol precedes the SSS subframe symbol.

9. The method of claim 8, wherein the wireless network comprises a Long Term Evolution (LTE) New Carrier Type (NCT) network.

10. The method of claim 8, wherein the first duplexing mode is one of Frequency-Division Duplexing (FDD) and Time-Division Duplexing (TDD).

11. The method of claim 8, wherein the PSS subframe symbol and the SSS subframe symbol are detected at adjoining symbol periods of the downlink communication.

12. The method of claim 8, wherein the PSS subframe symbol is detected at a second Orthogonal Frequency-Division Multiplexing (OFDM) symbol period of a plurality of subframes of the downlink communication.

13. The method of claim 8, wherein the SSS subframe symbol is detected at a second OFDM symbol period of a plurality of subframes of the downlink communication.

14. The method of claim 8, wherein the PSS subframe symbol and the SSS subframe symbol are detected at adjoining OFDM symbol periods of a subframe zero (subframe 0) and a subframe five (subframe 5) of a radio frame of the downlink communication.

15. A wireless network comprising:
a network base station configured to provide a downlink communication to a mobile communication device, the downlink communication provided by the base station including a primary synchronization signal (PSS) at a PSS subframe symbol of the downlink communication, and a secondary synchronization signal (SSS) at an SSS subframe symbol of the downlink communication;
wherein the PSS subframe symbol follows the SSS subframe symbol when the downlink communication is duplexed using a first duplexing mode, and wherein the PSS subframe symbol precedes the SSS subframe symbol when the downlink communication is duplexed using a second duplexing mode.

16. The wireless network of claim 15, wherein the wireless network comprises a Long Term Evolution (LTE) New Carrier Type (NCT) network.

17. The wireless network of claim 15, wherein the first duplexing mode is one of Frequency-Division Duplexing (FDD) and Time-Division Duplexing (TDD).

18. The wireless network of claim 15, wherein the PSS subframe symbol and the SSS subframe symbol are included at adjoining symbol periods of the downlink communication.

19. The wireless network of claim 15, wherein the PSS subframe symbol is included at a second Orthogonal Frequency-Division Multiplexing (OFDM) symbol period of a plurality of subframes of the downlink communication.

20. The wireless network of claim 15, wherein the SSS subframe symbol is included at a second OFDM symbol period of a plurality of subframes of the downlink communication.
